(19) United States
(12) Patent Application Publication
(10) Pub. No.: US 2026/0249837 A1
(43) Pub. Date: Aug. 27, 2026

(54) APPARATUS AND METHOD FOR CONTROLLING VEHICLE MOTION

(71) Applicants: Hyundai Motor Company, Seoul (KR); Kia Corporation, Seoul (KR)

(72) Inventor: Sheen Gil KANG, Hwaseong-Si (KR)

(73) Assignees: Hyundai Motor Company, Seoul (KR); Kia Corporation, Seoul (KR)

(21) Appl. No.: 19/271,512

(22) Filed: Jul. 16, 2025

(30) Foreign Application Priority Data
Feb. 24, 2025 (KR) 10-2025-0023816

(51) Int. Cl. B60W 30/02; B60W 60/00

(52) U.S. Cl. CPC B60W 30/025; B60W 60/0013; B60W 2420/403; B60W 2540/223; B60W 2720/16; B60W 2720/18

(57) ABSTRACT

In a vehicle motion control apparatus and a method of controlling thereof, based on passenger motion, capable of providing vehicle motion which is synchronized with passenger motion within a vehicle, a recognizer is configured to obtain passenger movement information from an image including a passenger in a vehicle, to determine whether or not a passenger groove motion exists, in response to a case where the image is input, a determiner is configured to obtain vehicle status information in response to a case where a passenger groove motion exists in the image to determine whether vehicle motion control is possible and extract features of the passenger groove motion based on concluding that the vehicle motion control is possible, and a controller is configured to generate a target vehicle motion based on the features and control a vehicle motion by driving an actuator corresponding to the target vehicle motion.

### CROSS-REFERENCE TO RELATED APPLICATION

The present application claims priority to and the benefit of Korean Patent Application No. 10-2025-0023816, filed with the Korean Intellectual Property Office on Feb. 24, 2025, the entire contents of which are incorporated herein by reference.

### BACKGROUND

### Field

The present disclosure relates to a vehicle motion control apparatus and method, and more particularly, to a vehicle motion control technology based on a passenger motion, capable of providing a vehicle motion which is synchronized with the passenger motion within a vehicle.

### Description of the Related Art

In general, an autonomous vehicle is a vehicle capable of recognizing a driving environment thereof and driving to a destination without a driver operating the vehicle.

With advancements in a level of autonomous vehicles, drivers are freed from the responsibilities of operating the vehicle and keeping their focus on a road ahead, enabling them to enjoy a variety of activities such as listening to music, watching movies, reading, and conducting meetings within the autonomous vehicle.

Passengers in such autonomous vehicles may feel confined and bored during long-distance travel due to maintaining a static posture in a limited space, and in some cases, they may experience discomfort caused by symptoms of motion sickness.

Accordingly, in the future, there is a demand for the development of a vehicle motion control apparatus capable of controlling vehicle motion to synchronize with the repetitive movement actions of passengers in the vehicle, thereby providing interest and fun to the passengers.

### PRIOR ART DOCUMENT

### [Patent Document]

Korean Patent Publication No. 10-2024-0115409 (Jul. 26, 2024)

### SUMMARY

An exemplary embodiment of the present disclosure attempts to provide a vehicle motion control apparatus and method, configured for providing interest and fun to vehicle passengers and maximizing passenger mood by extracting features of a passenger groove motion from a vehicle interior image to generate a target vehicle motion, controlling a vehicle motion corresponding to the target vehicle motion, and providing a vehicle motion synchronized with the passenger groove motion.

The technical objects of the present disclosure are not limited to the objects mentioned above, and other technical objects not mentioned may be clearly understood by those skilled in the art from the description of the claims.

An exemplary embodiment of the present disclosure provides a vehicle motion control apparatus including a recognizer configured to obtain passenger movement information from an image including a passenger in a vehicle, and to determine whether or not a passenger groove motion exists, based on that the image is input, a determiner configured to obtain vehicle status information based on that a passenger groove motion exists in the image to determine whether vehicle motion control is possible and extract features of the passenger groove motion based on concluding that the vehicle motion control is possible, and a controller configured to generate a target vehicle motion based on the features and control a vehicle motion by driving an actuator corresponding to the target vehicle motion.

In an exemplary embodiment of the present disclosure, the recognizer may be configured to obtain the image of the passenger from a camera mounted inside the vehicle based on that a driver input requesting the vehicle motion control corresponding to the passenger groove motion is received upon determining the passenger groove motion, verify whether a predetermined body motion of the passenger is repetitive from the image, and conclude that the passenger groove motion exists based on that the predetermined body motion of the passenger is repetitive.

In an exemplary embodiment of the present disclosure, the determiner may be configured to determine whether the vehicle motion control is possible by checking whether the vehicle is stopped, whether there is a risk due to a vehicle motion, and whether there is a road slope from the vehicle status information.

In an exemplary embodiment of the present disclosure, the determiner may be configured to separate a predetermined body motion of the passenger by frequency, and analyze the frequency to extract the features of the passenger groove motion, including a groove frequency, a groove pattern, and a groove type.

In an exemplary embodiment of the present disclosure, the controller may be configured to obtain key feature information including a groove type, a groove frequency, a groove timing, a groove intensity, and a groove direction from the features of the passenger groove motion, and generate a target vehicle motion based on the key feature information.

In an exemplary embodiment of the present disclosure, the controller may be configured to set the target vehicle motion based on key feature information, check an implementable motion and a physical upper limit based on information related to mounted hardware of the vehicle, and modify the set target vehicle motion based on the checked implementable motion and the checked physical upper limit to generate a final target vehicle motion.

In an exemplary embodiment of the present disclosure, the controller may be configured to set a target vehicle motion including a target roll, a target pitch, a target surge, a target bounce, and a holding time based on the key feature information.

In an exemplary embodiment of the present disclosure, the controller may be configured to verify whether an unimplementable motion exists within the target vehicle motion set based on the determined implementable motion, in response to determining the implementable motion based on the information related to the mounted hardware of the vehicle, and modify the set target vehicle motion set to remove the unimplementable motion based on that the unimplementable motion exists.

In an exemplary embodiment of the present disclosure, the controller may be configured to check whether a motion exceeding the physical upper limit exists within the target vehicle motion set based on the physical upper limit which is determined based on the information related to the mounted hardware of the vehicle, and modify the set target vehicle motion set to modify the motion exceeding the physical upper limit to be below the physical upper limit based on that the motion exceeding the physical upper limit exists.

In an exemplary embodiment of the present disclosure, the controller may be configured to select the actuator which is implementable based on hardware mounted in the vehicle corresponding to the target vehicle motion, distribute a torque required to implement the target vehicle motion for each selected actuator, and control the vehicle motion by driving the selected actuator with the distributed torque.

Another embodiment of the present disclosure provides a vehicle motion control method for a vehicle motion control apparatus including a recognizer, a determiner, and a controller, including determining, by the recognizer, whether or not a passenger groove motion exists by obtaining passenger movement information from an image including a passenger in a vehicle, based on that the image is input, determining, by the determiner, whether vehicle motion control is possible by obtaining vehicle status information in response to concluding that the passenger groove motion exists in the image, extracting, by the determiner, features of the passenger groove motion based on concluding that the vehicle motion control is possible, generating a target vehicle motion based on the features, and controlling, by the controller, a vehicle motion by driving an actuator corresponding to the target vehicle motion.

According to the present technology, it may be possible to provide interest and fun to vehicle passengers and maximizing passenger mood by extracting features of a passenger groove motion from a vehicle interior image to generate a target vehicle motion, controlling a vehicle motion corresponding to the target vehicle motion, and providing a vehicle motion synchronized with the passenger groove motion.

Furthermore, various effects which may be directly or indirectly identified through the present specification may be provided.

### BRIEF DESCRIPTION OF THE DRAWINGS

FIG. 1 illustrates a view for describing an example vehicle including a vehicle motion control apparatus.

FIG. 2 and FIG. 3 each illustrate a block diagram showing an exemplary configuration of a vehicle motion control apparatus.

FIG. 4 illustrates a flowchart for describing an example process of extracting features of a passenger groove motion in a vehicle motion control apparatus.

FIG. 5A, FIG. 5B, FIG. 5C, and FIG. 5D illustrate a view for describing an example target vehicle motion in a vehicle motion control apparatus.

FIG. 6 illustrates a view for describing an example process of generating a target vehicle motion in a vehicle motion control apparatus.

FIG. 7A and FIG. 7B illustrate a view for describing an example process of determining a motor torque corresponding to a target vehicle motion in a vehicle motion control apparatus.

FIG. 8 illustrates a view for describing an example process of generating a target vehicle motion corresponding to an input content source in a vehicle motion control apparatus.

FIG. 9 illustrates a flowchart for describing an example vehicle motion control method.

FIG. 10 illustrates an example computing system for a vehicle.

### DETAILED DESCRIPTION

Hereinafter, some exemplary embodiments of the present disclosure will be described in detail with reference to exemplary drawings. It should be noted that in adding reference numerals to constituent elements of each drawing, the same constituent elements include the same reference numerals as possible even though they are indicated on different drawings. Furthermore, in describing exemplary embodiments of the present disclosure, when it is determined that detailed descriptions of related well-known configurations or functions interfere with understanding of the exemplary embodiments of the present disclosure, the detailed descriptions thereof will be omitted.

In describing constituent elements according to various embodiments of the present disclosure, terms such as first, second, A, B, (a), and (b) may be used. These terms are only for distinguishing the constituent elements from other constituent elements, and the nature, sequences, or orders of the constituent elements are not limited by the terms. Furthermore, all terms used herein including technical scientific terms include the same meanings as those which are generally understood by those skilled in the technical field to which an exemplary embodiment of the present disclosure pertains (those skilled in the art) unless they are differently defined. Terms defined in a generally used dictionary shall be construed to have meanings matching those in the context of a related art, and shall not be construed to have idealized or excessively formal meanings unless they are clearly defined in the present specification.

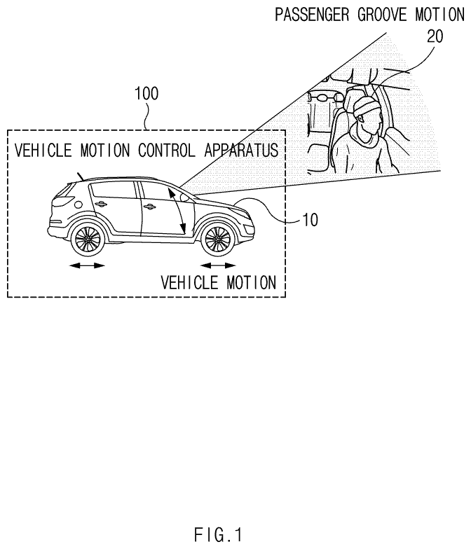

Hereinafter, various exemplary embodiments of the present disclosure will be described in detail with reference to FIG. 1 to FIG. 10.

FIG. 1 illustrates a view for describing an example vehicle including a vehicle motion control apparatus.

As illustrated in FIG. 1, the vehicle motion control apparatus 100 of the present disclosure may be configured to generate a target vehicle motion corresponding to a groove motion of a passenger 20 in a vehicle 10, and control a vehicle motion by driving an actuator corresponding to the target vehicle motion.

The vehicle motion control apparatus 100 may be configured to obtain passenger movement information from an image including the passenger 20 in the vehicle 10 in response to an image which is input to determine whether a passenger groove motion exists, obtain vehicle status information in response to the passenger groove motion existing in the image to determine whether vehicle motion control is possible, extract features of the passenger groove motion in response to a case where the vehicle motion control is possible to generate a target vehicle motion, and drives an actuator corresponding to the target vehicle motion to control the vehicle motion.

Herein, the vehicle motion control apparatus 100 may be configured to obtain an image of the passenger 20 from a camera mounted inside the vehicle 10 in response to a case where a driver input requesting the vehicle motion control corresponding to the passenger groove motion is received, determine whether a specific body motion of the passenger 20 is repetitive from the image, and determine that a passenger groove motion exists in response to a case where the specific body motion of the passenger 20 is repetitive.

Furthermore, the vehicle motion control apparatus 100 may be configured to determine whether the vehicle motion control is possible by checking whether the vehicle is stopped, whether there is a risk due to a vehicle motion, and whether there is a road slope from the vehicle status information.

Next, the vehicle motion control apparatus 100 may be configured to separate a specific body motion of the passenger 20 by frequency, and analyze the frequency, to extract the features of the passenger groove motion, including a groove frequency, a groove pattern, and a groove type.

Next, the vehicle motion control apparatus 100 may be configured to obtain key feature information including a groove type, a groove frequency, a groove timing, a groove intensity, and a groove direction from the features of the passenger groove motion, and generate a target vehicle motion based on the key feature information.

Herein, the vehicle motion control apparatus 100 may be configured to set the target vehicle motion based on key feature information, check an implementable motion and a physical upper limit based on information related to mounted hardware of the vehicle 10, and modify the set target vehicle motion based on the checked implementable motion and the checked physical upper limit to generate a final target vehicle motion.

For example, the vehicle motion control apparatus 100 may be configured to set a target vehicle motion including a target roll, a target pitch, a target surge, a target bounce, and a holding time based on key feature information.

Furthermore, the vehicle motion control apparatus 100 may be configured to verify whether an unimplementable motion exists within the target vehicle motion set based on the determined implementable motion in response to determining that the implementable motion based on the information related to the mounted hardware of the vehicle 10, and modify the target vehicle motion set to remove the unimplementable motion in response to a case where the unimplementable motion exists.

Furthermore, the vehicle motion control apparatus 100 may be configured to check whether a motion exceeding the physical upper limit exists within the target vehicle motion set based on the physical upper limit which is determined based on the information related to the mounted hardware of the vehicle 10, and modify the target vehicle motion set to modify the motion exceeding the physical upper limit to be below the physical upper limit in response to a case where the motion exceeding the physical upper limit exists.

Next, the vehicle motion control apparatus 100 may be configured to select an actuator which is implementable based on hardware mounted in the vehicle 10 corresponding to the target vehicle motion, distribute a torque required to implement the target vehicle motion for each selected actuator, and control the vehicle motion by driving the selected actuator with the distributed torque.

In some cases, the vehicle motion control apparatus 100 may be configured to obtain vehicle status information to determine whether vehicle motion control is possible upon receiving a driver input requesting vehicle motion control corresponding to a music content, extract features of music beats from the music content to generate a target vehicle motion in response to a case where the vehicle motion control is possible, and drive an actuator corresponding to the target vehicle motion to control the vehicle motion.

In other cases, the vehicle motion control apparatus 100 may be configured to obtain vehicle status information to determine whether vehicle motion control is possible upon receiving a driver input requesting vehicle motion control corresponding to a movie content, extract features of sound effects from the move content to generate a target vehicle motion in response to a case where the vehicle motion control is possible, and drive an actuator corresponding to the target vehicle motion to control the vehicle motion.

In other cases, the vehicle motion control apparatus 100 may be configured to obtain vehicle status information to determine whether vehicle motion control is possible upon receiving a driver input requesting vehicle motion control corresponding to a game content, extract features of game environment from the game content to generate a target vehicle motion in response to a case where the vehicle motion control is possible, and drive an actuator corresponding to the target vehicle motion to control the vehicle motion.

Accordingly, according to the present technology, it may be possible to provide interest and fun to vehicle passengers and maximizing passenger mood by extracting features of a passenger groove motion from a vehicle interior image to generate a target vehicle motion, controlling a vehicle motion corresponding to the target vehicle motion, and providing a vehicle motion synchronized with the passenger groove motion.

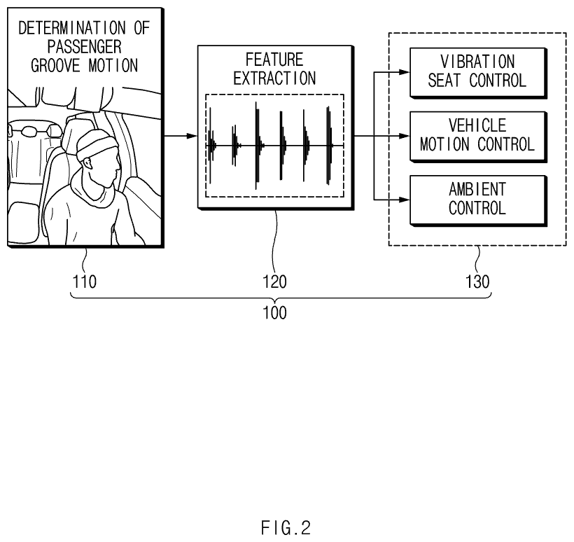

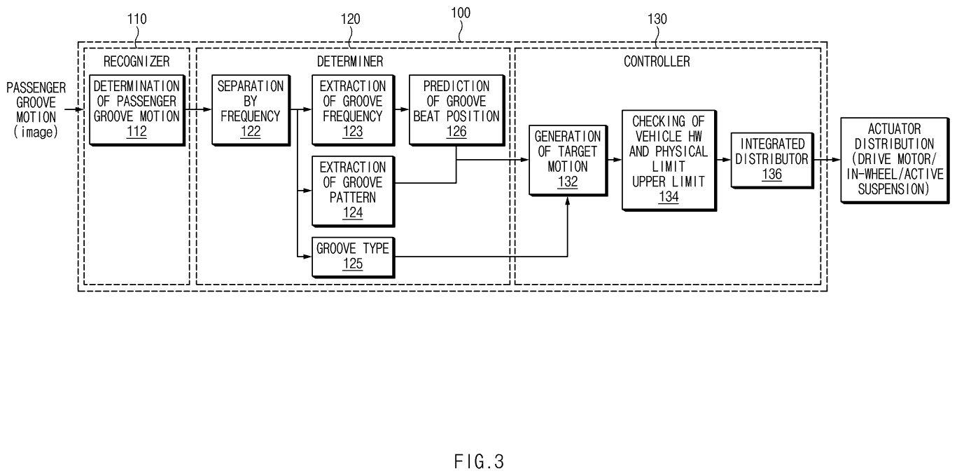

FIG. 2 and FIG. 3 each illustrate a block diagram showing an exemplary configuration of a vehicle motion control apparatus.

As illustrated in FIGS. 2 and 3, the vehicle motion control apparatus 100 of the present disclosure may include a recognizer 110 that is configured to determine whether a passenger groove motion exists, a determiner 120 that extracts features of the passenger groove motion, and a controller 130 that generates a target vehicle motion based on the features to control a vehicle motion.

Herein, in response to a case where an image including a passenger in a vehicle is input, the recognizer 110 may be configured to obtain passenger movement information from the image to determine whether or not a passenger groove motion exists.

That is, the recognizer 110 may be configured to obtain an image of the passenger from a camera mounted inside the vehicle in response to a case where a driver input requesting the vehicle motion control corresponding to the passenger groove motion is received, verify whether a specific body motion of the passenger is repetitive from the image, and determine that the passenger groove motion exists in response to a case where the specific body motion of the passenger is repetitive (112).

For example, the recognizer 110 may be configured to determine that the passenger groove motion exists in response to a case where a number of repetitions of the specific body motion of the passenger is greater than a predetermined reference number of times.

Next, the determiner 120 may be configured to obtain vehicle status information to determine whether vehicle motion control is possible in response to a case where the passenger groove motion exists in the image, and extract features of the passenger groove motion in response to a case where the vehicle motion control is possible.

Herein, the determiner 120 may be configured to determine whether the vehicle motion control is possible by checking whether the vehicle is stopped, whether there is a risk due to a vehicle motion, and whether there is a road slope from the vehicle status information.

For example, the determiner 120 may be configured to determine whether the vehicle motion control is possible in response to a case where all of the following conditions are satisfied: a first determination condition for vehicle stop based on a preset vehicle stop state, a second determination condition for no risk due to a vehicle motion based on a preset risk range, and a third determination condition for no road slope based on a preset slope range.

Accordingly, the determiner 120 may be configured to separate a specific body motion of the passenger by frequency (122) and analyze the frequency to extract features of the passenger groove motion, including a groove frequency 123, a groove pattern 124, and a groove type 125.

Herein, in separating the specific body motion of the passenger by frequency, the determiner 120 may be configured to separate specific body motion image segments from the image of the passenger and further re-separate these specific body motion image segments by frequency.

Furthermore, the determiner 120 may be configured to predict a groove beat position based on the groove frequency in response to extracting features of the passenger groove motion (126).

For example, the determiner 120 may be configured to predict start and end points of a groove repetition motion and a time therebetween through the groove beat position.

Furthermore, in extracting features of the groove frequency 123, the determiner 120 may be configured to analyze the frequency to extract a fundamental frequency for the groove motion and extract features of a groove frequency including the fundamental frequency.

Furthermore, in extracting features of the groove pattern 124, the determiner 120 may be configured to analyze the frequency to extract an intensity for each groove motion and extract features of a groove pattern including the intensity for each groove motion.

Furthermore, in extracting features for the groove type 125, the determiner 120 may be configured to analyze the frequency to classify the groove motion into at least one of forward/backward direction, pitch direction, up and down direction, roll direction, and composite direction, and extract features of the groove type including the classified groove motion direction.

Next, the controller 130 may be configured to generate a target vehicle motion based on the features and control a vehicle motion by driving an actuator corresponding to the target vehicle motion.

Herein, the controller 130 may be configured to obtain key feature information including a groove type, a groove frequency, a groove timing, a groove intensity, and a groove direction from the features of the passenger groove motion, and generate a target vehicle motion based on the key feature information (132).

Furthermore, the controller 130 may be configured to set the target vehicle motion based on key feature information, check an implementable motion and a physical upper limit based on information related to mounted hardware of the vehicle (134), and modify the set target vehicle motion based on the checked implementable motion and the checked physical upper limit to generate a final target vehicle motion.

For example, the controller 130 may be configured to set a target vehicle motion including a target roll, a target pitch, a target surge, a target bounce, and a holding time based on key feature information.

Furthermore, in a case of confirming the implementable motion, the controller 130 may be configured to confirm surge and pitch as implementable motion in response to determining that the vehicle includes front and rear wheel motors from the information related to the mounted hardware of the vehicle, confirm surge, pitch, roll, and roll holding as implementable motions in response to determining that the vehicle includes an in-wheel motor from the information related to the mounted hardware of the vehicle, and confirm pitch, roll, bounce, and motion holding as implementable motions in response to determining that the vehicle includes an active suspension from the information related to the mounted hardware of the vehicle.

Herein, in a case of confirming the implementable motion, the controller 130 may be configured to confirm a specific single motion corresponding to one mounted hardware as the implementable motion in response to determining that the vehicle includes one of the front and rear wheel motors, the in-wheel motor, or the active suspension from the information related to the mounted hardware of the vehicle, and confirm composite motions corresponding to multiple mounted hardwares as implementable motions in response to determining that the vehicle includes multiple front and rear wheel motors, the in-wheel motor, and the active suspension from the information related to the mounted hardware of the vehicle.

Furthermore, the controller 130 may be configured to verify whether an unimplementable motion exists within the target vehicle motion set based on the determined implementable motion, in response to determining the implementable motion based on the information related to the mounted hardware of the vehicle, and modify the target vehicle motion set to remove the unimplementable motion in response to a case where the unimplementable motion exists.

Furthermore, the controller 130 may be configured to check whether a motion exceeding the physical upper limit exists within the target vehicle motion set based on the physical upper limit which is determined based on the information related to the mounted hardware of the vehicle, and modify the target vehicle motion set to modify the motion exceeding the physical upper limit to be below the physical upper limit in response to a case where the motion exceeding the physical upper limit exists.

Furthermore, the controller 100 may be configured to generate the target vehicle motion by adjusting a control variable of the target vehicle motion based on a passenger input for modifying the control variable of the target vehicle motion in response to receiving the passenger input.

Next, the controller 130 may be configured to select the actuator which is implementable based on hardware mounted in the vehicle corresponding to the target vehicle motion, distribute a torque required to implement the target vehicle motion for each selected actuator, and control the vehicle motion by driving the selected actuator with the distributed torque (136).

For example, the controller 130 may be configured to extract a groove bit position and size by determining a first equation of x(t)=A1·δ(t−t1)+A2·δ(t−t2)+ . . . . In a case where the mounted hardware of the vehicle is a single drive motor and the groove feature is modeled by impulse training for the groove motion in a pitch direction to determine a single motor torque (where Aᵢ indicates a groove density, tᵢ indicates the groove beat position, i is the integer and δ(t) indicates a Dirac delta function), and determine a single motor torque T(m) corresponding to the target vehicle motion by a second equation of

$$T ( m ) = \frac{{ω}_{n}^{2}}{{s}^{2} + 2 {ζω}_{n} s + {ω}_{n}^{2}} X ( s )$$

(where ωn=2π BPM/60 and ζ indicates a damping coefficient, and X(s) is the Laplace Transform of x(t)).

Accordingly, according to the present technology, it may be possible to provide interest and fun to vehicle passengers and maximizing passenger mood by extracting features of a passenger groove motion from a vehicle interior image to generate a target vehicle motion, controlling a vehicle motion corresponding to the target vehicle motion, and providing a vehicle motion synchronized with the passenger groove motion.

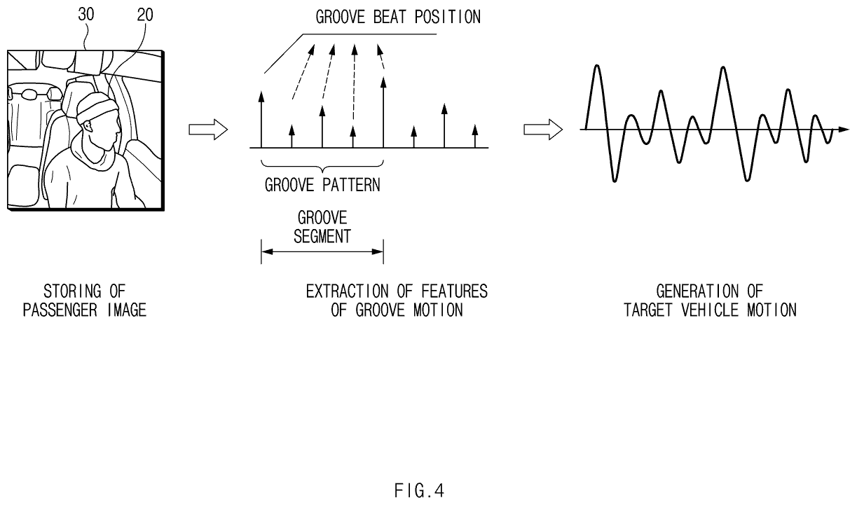

FIG. 4 illustrates a flowchart for describing an example process of extracting features of a passenger groove motion in a vehicle motion control apparatus.

As illustrated in FIG. 4, according to an exemplary embodiment of the present disclosure, it may be possible to extract features of the groove motion of the passenger 20 in response to a case where the groove motion of the passenger 20 exists in an image 30.

Herein, according to an exemplary embodiment of the present disclosure, it may be possible to separate a specific body motion of the passenger 20 by frequency, and analyze the frequency to extract the features of the passenger groove motion, including a groove frequency, a groove pattern, and a groove type.

Furthermore, according to an exemplary embodiment of the present disclosure, it may be possible to predict a groove beat position based on the groove frequency.

For example, according to an exemplary embodiment of the present disclosure, it may be possible to predict start and end points of a groove repetition motion and a time therebetween through the groove beat position thereof.

Furthermore, according to an exemplary embodiment of the present disclosure, it may be possible to analyze the frequency to extract a fundamental frequency for the groove motion and extract features of a groove frequency including the fundamental frequency.

Furthermore, according to an exemplary embodiment of the present disclosure, it may be possible to analyze the frequency to extract an intensity for each groove motion and extract features of a groove pattern including the intensity for each groove motion.

Furthermore, according to an exemplary embodiment of the present disclosure, it may be possible to analyze the frequency to classify the groove motion into at least one of forward/backward direction, pitch direction, up and down direction, roll direction, and composite direction, and extract features of the groove type including the classified groove motion direction thereof.

Next, according to an exemplary embodiment of the present disclosure, it may be possible to generate a target vehicle motion based on the extracted features.

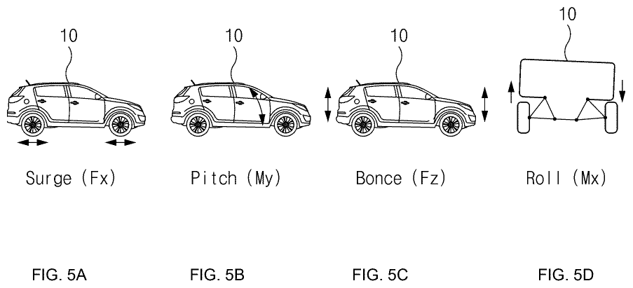

FIG. 5A, FIG. 5B, FIG. 5C, and FIG. 5D illustrate a view for describing an example target vehicle motion in a vehicle motion control apparatus.

As illustrated in FIG. 5A, FIG. 5B, FIG. 5C, and FIG. 5D, according to an exemplary embodiment of the present disclosure, it may be possible to set a target vehicle motion based on key feature information, and generate the target vehicle motion based on an implementable motion and a physical limit upper limit.

For example, according to an exemplary embodiment of the present disclosure, it may be possible to set a target vehicle motion including a target roll, a target pitch, a target surge, a target bounce, and a holding time based on key feature information.

As shown in FIG. 5A, according to an exemplary embodiment of the present disclosure, it may be possible to control the vehicle 10 into a surge motion in a case where the target vehicle motion is a target surge.

As shown in FIG. 5B, according to an exemplary embodiment of the present disclosure, it may be possible to control the vehicle 10 in pitch motion in a case where the target vehicle motion is a target pitch.

As shown in FIG. 5C, according to an exemplary embodiment of the present disclosure, it may be possible to control the vehicle 10 in bounce motion in a case where the target vehicle motion is a target bounce.

As shown in FIG. 5D, according to an exemplary embodiment of the present disclosure, it may be possible to control the vehicle 10 in roll motion in a case where the target vehicle motion is a target roll.

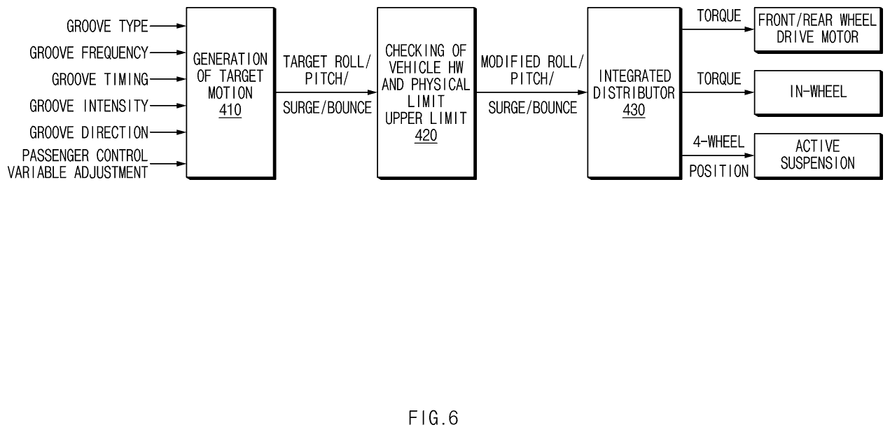

FIG. 6 illustrates a view for describing an example process of generating a target vehicle motion in a vehicle motion control apparatus.

As illustrated in FIG. 6, according to an exemplary embodiment of the present disclosure, it may be possible to obtain key feature information including a groove type, a groove frequency, a groove timing, a groove intensity, a groove direction, and passenger control variable adjustment from characteristics of a passenger groove motion, and generate a vehicle target motion based on the key feature information (410).

For example, according to an exemplary embodiment of the present disclosure, it may be possible to generate a target vehicle motion including a target roll, a target pitch, a target surge, a target bounce, and a holding time based on the key feature information.

Next, according to an exemplary embodiment of the present disclosure, it may be possible to check an implementable motion and a physical upper limit based on information related to mounted hardware of the vehicle (420), and modify the generated target vehicle motion based on the checked implementable motion and the checked physical upper limit to generate a final target vehicle motion.

Herein, in a case of confirming the implementable motion, according to an exemplary embodiment of the present disclosure, it may be possible to confirm surge and pitch as implementable motion in response to determining that the vehicle includes front and rear wheel motors from the information related to the mounted hardware of the vehicle, confirm surge, pitch, roll, and roll holding as implementable motions in response to determining that the vehicle includes an in-wheel motor from the information related to the mounted hardware of the vehicle, and confirm pitch, roll, bounce, and motion holding as implementable motions in response to determining that the vehicle includes an active suspension from the information related to the mounted hardware of the vehicle.

For example, according to an exemplary embodiment of the present disclosure, it may be possible to confirm a specific single motion corresponding to one mounted hardware as the implementable motion in response to determining that the vehicle includes one of the front and rear wheel motors, the in-wheel motor, or the active suspension from the information related to the mounted hardware of the vehicle, and confirm composite motions corresponding to multiple mounted hardwares as implementable motions in response to determining that the vehicle includes multiple of the front and rear wheel motors, the in-wheel motor, and the active suspension from the information related to the mounted hardware of the vehicle.

Furthermore, according to an exemplary embodiment of the present disclosure, it may be possible to verify whether an unimplementable motion exists within the target vehicle motion set based on the determined implementable motion, in response to determining the implementable motion based on the information related to the mounted hardware of the vehicle, and modify the target vehicle motion set to remove the unimplementable motion in response to a case where the unimplementable motion exists.

Furthermore, according to an exemplary embodiment of the present disclosure, it may be possible to check whether a motion exceeding the physical upper limit exists within the target vehicle motion set based on the physical upper limit which is determined based on the information related to the mounted hardware of the vehicle, and modify the target vehicle motion set to modify the motion exceeding the physical upper limit to be below the physical upper limit in response to a case where the motion exceeding the physical upper limit exists.

Then, according to an exemplary embodiment of the present disclosure, it may be possible to select the actuator which is implementable based on hardware mounted in the vehicle corresponding to the target vehicle motion through an integrated distributor, distribute a torque required to implement the target vehicle motion for each selected actuator, and control the vehicle motion by driving the selected actuator with the distributed torque (430).

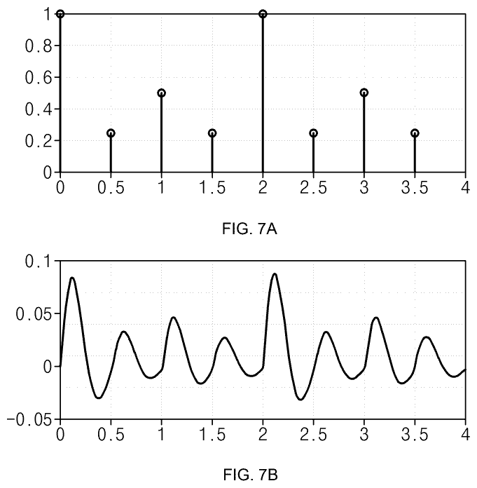

FIG. 7A and FIG. 7B illustrate a view for describing an example process of determining a motor torque corresponding to a target vehicle motion in a vehicle motion control apparatus.

As illustrated in FIG. 7A and FIG. 7B, according to an exemplary embodiment of the present disclosure, the mounted hardware of the vehicle may be a single drive motor and the groove feature may be modeled by impulse training for the groove motion in a pitch direction to determine a single motor torque.

As an exemplary embodiment of the present disclosure, as shown in FIG. 7A, according to an exemplary embodiment of the present disclosure, it may be possible to extract a groove bit position and size by determining a first equation of x(t)=A1·δ(t−t1)+A2·δ(t−t2)+ . . . (where Aᵢ indicates a groove density, tᵢ indicates the groove beat position, and δ(t) indicates a Dirac delta function).

As another embodiment, as shown in FIG. 7B, according to an exemplary embodiment of the present disclosure, it may be possible to determine a single motor torque corresponding to the target vehicle motion by a second equation of

$$T ( m ) = \frac{{ω}_{n}^{2}}{{s}^{2} + 2 {ζω}_{n} s + {ω}_{n}^{2}} X ( s )$$

(where ωn=2π BPM/60 and ζ indicates a damping coefficient).

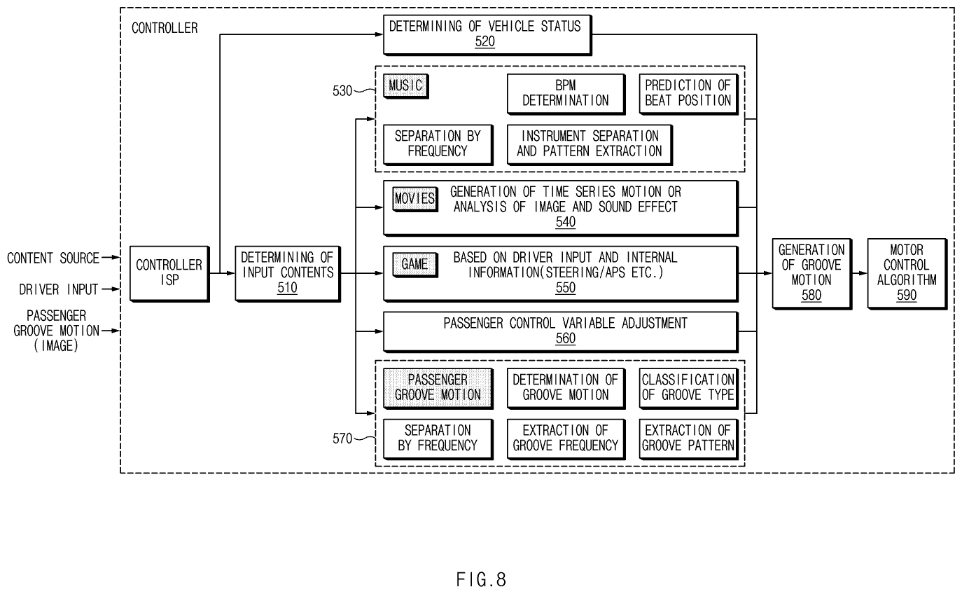

FIG. 8 illustrates a view for describing an example process of generating a target vehicle motion corresponding to an input content source in a vehicle motion control apparatus.

As illustrated in FIG. 8, according to an exemplary embodiment of the present disclosure, it may be possible to determine a category of input contents in a case where a content source, a driver input, and a passenger groove motion image are input (510), and classify the input content by category to extract features by category (510).

Next, according to an exemplary embodiment of the present disclosure, it may be possible to obtain vehicle status information to determine whether vehicle motion control is possible in response to a case where the passenger groove motion exists in the image (520), and extract features of the passenger groove motion in response to a case where the vehicle motion control is possible.

Herein, according to an exemplary embodiment of the present disclosure, it may be possible to extract features of music beats from a music content in a case where the category of input contents is a music content (530), generate a target vehicle motion (580), and control a vehicle motion by driving an actuator corresponding to the target vehicle motion through a motor control algorithm (590).

Furthermore, according to an exemplary embodiment of the present disclosure, it may be possible to extract features of sound effects from a movie content in a case where the category of input contents is the movie content (540), generate a target vehicle motion (580), and control a vehicle motion by driving an actuator corresponding to the target vehicle motion through a motor control algorithm (590).

Furthermore, according to an exemplary embodiment of the present disclosure, it may be possible to extract features for a game environment from a game content in a case where the category of input contents is a music content (550), generate a target vehicle motion (580), and control a vehicle motion by driving an actuator corresponding to the target vehicle motion through a motor control algorithm (590).

Furthermore, according to an exemplary embodiment of the present disclosure, it may be possible to generate a vehicle target motion (580) by adjusting a control variable of the vehicle target motion based on a passenger control variable adjustment input for adjusting the control variable of the target vehicle motion (560) in response to receiving the control variable adjustment input, and control a vehicle motion by driving an actuator corresponding to the target vehicle motion through a motor control algorithm (590).

Furthermore, according to an exemplary embodiment of the present disclosure, it may be possible to separate a specific body motion of the passenger by frequency in a case where the category of input contents is a passenger groove motion, and analyze the frequency to extract the features of the passenger groove motion, including a groove frequency, a groove pattern, and a groove type (570).

Next, according to an exemplary embodiment of the present disclosure, it may be possible to obtain key feature information including a groove type, a groove frequency, a groove timing, a groove intensity, and a groove direction from the features of the passenger groove motion, and generate a target vehicle motion based on the key feature information (580).

Herein, according to an exemplary embodiment of the present disclosure, it may be possible to set the target vehicle motion based on key feature information, check an implementable motion and a physical upper limit based on information related to mounted hardware of the vehicle, and modify the set target vehicle motion based on the checked implementable motion and the checked physical upper limit to generate a final target vehicle motion.

Next, according to an exemplary embodiment of the present disclosure, it may be possible to select the actuator which is implementable based on hardware mounted in the vehicle corresponding to the target vehicle motion, distribute a torque required to implement the target vehicle motion for each selected actuator, and control the vehicle motion by driving the selected actuator with the distributed torque (590).

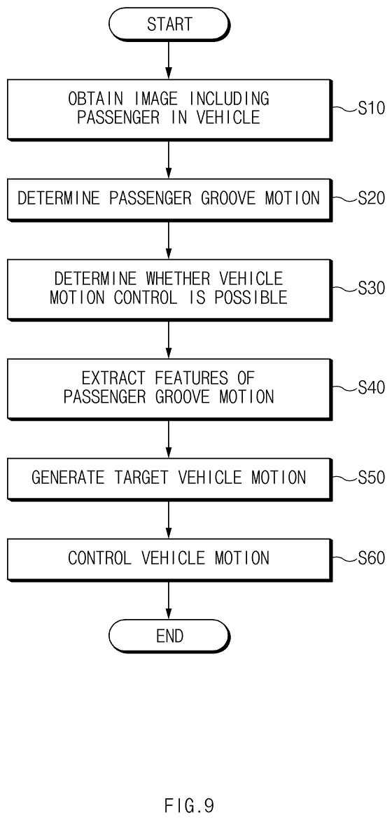

FIG. 9 illustrates a flowchart for describing an example vehicle motion control method.

As illustrated in FIG. 9, according to an exemplary embodiment of the present disclosure, it may be possible to obtain an image including a passenger in a vehicle (S10).

Accordingly, according to an exemplary embodiment of the present disclosure, it may be possible to determine whether a passenger groove motion exists by obtaining passenger movement information from the image including a passenger in a vehicle (S20).

Herein, according to an exemplary embodiment of the present disclosure, it may be possible to determine whether a specific body motion of a passenger is repetitive from an image obtained by photographing the passenger by a camera mounted inside a vehicle, and determine that the passenger groove movement exists in response to determining that the specific body motion of the passenger is repetitive.

Next, according to an exemplary embodiment of the present disclosure, it may be possible to determine whether vehicle motion control is possible by obtaining vehicle status information in response to concluding that the passenger groove motion exists in the image (S30).

Herein, according to an exemplary embodiment of the present disclosure, it may be possible to determine whether the vehicle motion control is possible by checking whether the vehicle is stopped, whether there is a risk due to a vehicle motion, and whether there is a road slope from the vehicle status information.

Next, according to an exemplary embodiment of the present disclosure, it may be possible to extract features of the passenger groove motion in response to determining that vehicle motion control is possible (S40).

Herein, according to an exemplary embodiment of the present disclosure, it may be possible to separate a specific body motion of the passenger by frequency, and analyze the frequency to extract the features of the passenger groove motion, including a groove frequency, a groove pattern, and a groove type.

Then, according to an exemplary embodiment of the present disclosure, it may be possible to generate a target vehicle motion based on the features (S50).

Herein, according to an exemplary embodiment of the present disclosure, it may be possible to obtain key feature information including a groove type, a groove frequency, a groove timing, a groove intensity, and a groove direction from the features of the passenger groove motion, and generate a target vehicle motion based on the key feature information.

Furthermore, according to an exemplary embodiment of the present disclosure, it may be possible to set the target vehicle motion based on key feature information, check an implementable motion and a physical upper limit based on information related to mounted hardware of the vehicle, and modify the set target vehicle motion based on the checked implementable motion and the checked physical upper limit to generate a final target vehicle motion.

For example, according to an exemplary embodiment of the present disclosure, it may be possible to set a target vehicle motion including a target roll, a target pitch, a target surge, a target bounce, and a holding time based on the key feature information.

Furthermore, according to an exemplary embodiment of the present disclosure, it may be possible to verify whether an unimplementable motion exists within the target vehicle motion set based on the determined implementable motion, in response to determining the implementable motion based on the information related to the mounted hardware of the vehicle, and modify the target vehicle motion set to remove the unimplementable motion in response to a case where the unimplementable motion exists.

Furthermore, according to an exemplary embodiment of the present disclosure, it may be possible to check whether a motion exceeding the physical upper limit exists within the target vehicle motion set based on the physical upper limit which is determined based on the information related to the mounted hardware of the vehicle, and modify the target vehicle motion set to modify the motion exceeding the physical upper limit to be below the physical upper limit in response to a case where the motion exceeding the physical upper limit exists.

Next, according to an exemplary embodiment of the present disclosure, it may be possible to control a vehicle motion by driving an actuator corresponding to the vehicle target motion (S60).

Herein, according to an exemplary embodiment of the present disclosure, it may be possible to select the actuator which is implementable based on hardware mounted in the vehicle corresponding to the target vehicle motion, distribute a torque required to implement the target vehicle motion for each selected actuator, and control the vehicle motion by driving the selected actuator with the distributed torque.

Accordingly, according to the present technology, it may be possible to provide interest and fun to vehicle passengers and maximizing passenger mood by extracting features of a passenger groove motion from a vehicle interior image to generate a target vehicle motion, controlling a vehicle motion corresponding to the target vehicle motion, and providing a vehicle motion synchronized with the passenger groove motion.

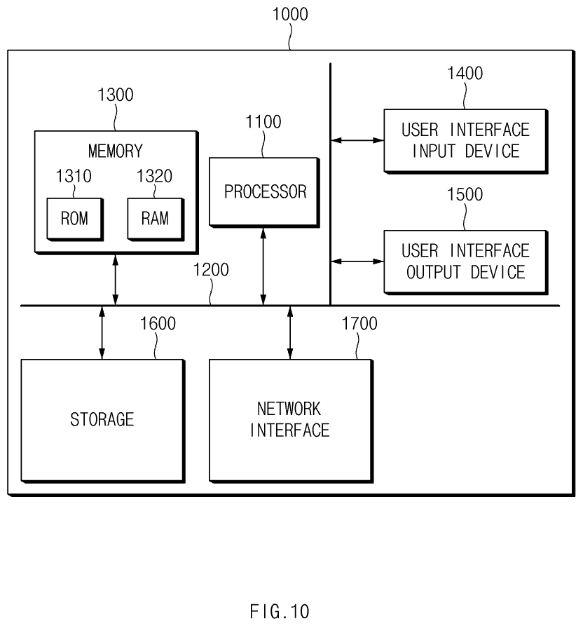

FIG. 10 illustrates an example computing system for a vehicle.

Referring to FIG. 10, the computing system 1000 includes at least one processor 1100 connected through a bus 1200, a memory 1300, a user interface input device 1400, a user interface output device 1500, and a storage 1600, and a network interface 1700.

The processor 1100 may be a central processing unit (CPU) or a semiconductor device that is configured to perform processing on commands stored in the memory 1300 and/or the storage 1600. The memory 1300 and the storage 1600 may include various types of volatile or nonvolatile storage media. For example, the memory 1300 may include a read only memory (ROM) and a random access memory (RAM).

Accordingly, steps of a method or algorithm described in connection with the exemplary embodiments included herein may be directly implemented by hardware, a software module, or a combination of the two, executed by the processor 1100. The software module may reside in a storage medium (i.e., the memory 1300 and/or the storage 1600) such as a RAM memory, a flash memory, a ROM memory, an EPROM memory, an EEPROM memory, a register, a hard disk, a removable disk, and a CD-ROM.

An exemplary storage medium is coupled to the processor 1100, which can read information from and write information to the storage medium. Alternatively, the storage medium may be integrated with the processor 1100. The processor and the storage medium may reside within an application specific IC (ASIC). The ASIC may reside within a user terminal. Alternatively, the processor and the storage medium may reside as separate components within the user terminal.

The above description is merely illustrative of the technical idea of the present disclosure, and those skilled in the art to which the present disclosure pertains may make various modifications and variations without departing from the essential characteristics of the present disclosure.

Therefore, the exemplary embodiments included in the present disclosure are not intended to limit the technical ideas of the present disclosure, but to explain them, and the scope of the technical ideas of the present disclosure is not limited by these exemplary embodiments. The protection range of the present disclosure should be interpreted by the claims below, and all technical ideas within the equivalent range should be interpreted as being included in the scope of the present disclosure.

What is claimed is:

1. A vehicle motion control apparatus comprising:
a recognizer configured to obtain passenger movement information from an image including a passenger in a vehicle, and to determine whether a passenger groove motion exists, based on that the image is input;
a determiner configured to obtain vehicle status information based on that the passenger groove motion exists in the image to determine whether vehicle motion control is possible, and extract features of the passenger groove motion based on concluding that the vehicle motion control is possible; and
a controller configured to generate a target vehicle motion based on the features and control a vehicle motion by driving an actuator corresponding to the target vehicle motion.

2. The vehicle motion control apparatus of claim 1, wherein the recognizer is further configured to obtain the image of the passenger from a camera mounted inside the vehicle based on that a driver input requesting the vehicle motion control corresponding to the passenger groove motion is received upon determining the passenger groove motion, verify whether a predetermined body motion of the passenger is repetitive from the image, and conclude that the passenger groove motion exists based on that the predetermined body motion of the passenger is repetitive.

3. The vehicle motion control apparatus of claim 1, wherein the determiner is further configured to determine whether the vehicle motion control is possible by checking whether the vehicle is stopped, whether there is a risk due to a vehicle motion, and whether there is a road slope from the vehicle status information.

4. The vehicle motion control apparatus of claim 1, wherein the determiner is further configured to separate a predetermined body motion of the passenger by frequency, and analyze the frequency to extract the features of the passenger groove motion, including a groove frequency, a groove pattern, and a groove type.

5. The vehicle motion control apparatus of claim 1, wherein the controller is further configured to obtain key feature information including a groove type, a groove frequency, a groove timing, a groove intensity, and a groove direction from the features of the passenger groove motion, and generate the target vehicle motion based on the key feature information.

6. The vehicle motion control apparatus of claim 5, wherein the controller is further configured to set the target vehicle motion based on the key feature information, check an implementable motion and a physical upper limit based on information related to mounted hardware of the vehicle, and modify the set target vehicle motion based on the checked implementable motion and the checked physical upper limit to generate a final target vehicle motion.

7. The vehicle motion control apparatus of claim 6, wherein the controller is further configured to set the target vehicle motion including a target roll, a target pitch, a target surge, a target bounce, and a holding time based on the key feature information.

8. The vehicle motion control apparatus of claim 6, wherein the controller is further configured to verify whether an unimplementable motion exists within the target vehicle motion set based on the determined implementable motion, in response to determining the implementable motion based on the information related to the mounted hardware of the vehicle, and modify the set target vehicle motion set to remove the unimplementable motion based on that the unimplementable motion exists.

9. The vehicle motion control apparatus of claim 6, wherein the controller is further configured to check whether a motion exceeding the physical upper limit exists within the target vehicle motion set based on the physical upper limit which is determined based on the information related to the mounted hardware of the vehicle, and modify the set target vehicle motion set to modify the motion exceeding the physical upper limit to be below the physical upper limit based on that the motion exceeding the physical upper limit exists.

10. The vehicle motion control apparatus of claim 1, wherein the controller is further configured to select the actuator which is implementable based on hardware mounted in the vehicle corresponding to the target vehicle motion, distribute a torque required to implement the target vehicle motion for each selected actuator, and control the vehicle motion by driving the selected actuator with the distributed torque.

11. A method for controlling a vehicle motion control apparatus including a recognizer, a determiner, and a controller, the method comprising:
determining, by the recognizer, whether a passenger groove motion exists by obtaining passenger movement information from an image including a passenger in a vehicle, based on that the image is input;
determining, by the determiner, whether vehicle motion control is possible by obtaining vehicle status information in response to concluding that the passenger groove motion exists in the image;
extracting, by the determiner, features of the passenger groove motion based on concluding that the vehicle motion control is possible;
generating a target vehicle motion based on the features;
controlling, by the controller, a vehicle motion by driving an actuator corresponding to the target vehicle motion.

12. The method of claim 11, wherein the determining of whether the passenger groove motion exists includes:
obtaining an image of the passenger from a camera mounted inside the vehicle based on that a driver input requesting the vehicle motion control corresponding to the passenger groove motion is received;
verifying whether a predetermined body motion of the passenger is repetitive from the image; and
determining that the passenger groove motion exists based on that the predetermined body motion of the passenger is repetitive.

13. The method of claim 11, wherein the determining of whether the vehicle motion control is possible includes determining whether the vehicle motion control is possible by checking whether the vehicle is stopped, whether there is a risk due to a vehicle motion, and whether there is a road slope from the vehicle status information.

14. The method of claim 11, wherein the extracting of the features of the passenger groove motion includes:
separating a predetermined body motion of the passenger by frequency; and
analyzing the frequency to extract the features of the passenger groove motion, including a groove frequency, a groove pattern, and a groove type.

15. The method of claim 11, wherein the generating of the target vehicle motion includes:
obtaining key feature information including a groove type, a groove frequency, a groove timing, a groove intensity, and a groove direction from the features of the passenger groove motion; and
generating the target vehicle motion based on the key feature information.

16. The method of claim 15, wherein the generating of the target vehicle motion includes:
setting the target vehicle motion based on the key feature information, checking an implementable motion and a physical upper limit based on information related to mounted hardware of the vehicle; and
modifying the set target vehicle motion based on the checked implementable motion and the checked physical upper limit to generate a final target vehicle motion.

17. The method of claim 16, wherein the setting of the target vehicle motion includes setting the target vehicle motion including a target roll, a target pitch, a target surge, a target bounce, and a holding time based on the key feature information.

18. The method of claim 16, wherein the modifying of the set target vehicle motion includes:
verifying whether an unimplementable motion exists within the target vehicle motion set based on the determined implementable motion, in response to determining the implementable motion based on the information related to the mounted hardware of the vehicle; and
modifying the set target vehicle motion set to remove the unimplementable motion based on that the unimplementable motion exists.

19. The method of claim 16, wherein the modifying of the set target vehicle motion includes:
checking whether a motion exceeding the physical upper limit exists within the target vehicle motion set based on the physical upper limit which is determined based on the information related to the mounted hardware of the vehicle; and
modifying the set target vehicle motion set to modify the motion exceeding the physical upper limit to be below the physical upper limit based on that the motion exceeding the physical upper limit exists.

20. The method of claim 11, wherein the controlling of the vehicle motion includes:
selecting the actuator which is implementable based on hardware mounted in the vehicle corresponding to the target vehicle motion;
distributing a torque required to implement the target vehicle motion for each selected actuator; and
controlling the vehicle motion by driving the selected actuator with the distributed torque.
